(19) United States
(12) Patent Application Publication
(10) Pub. No.: US 2014/0373411 A1
(43) Pub. Date: Dec. 25, 2014

(54) HOOKED MATERIAL FOR CONVEYING NON-VERBAL SPATIAL AND DIRECTIONAL MESSAGES

(71) Applicant: JOYCE UTTERBACK BUEHLER, SAN CLEMENTE, CA (US)

(72) Inventor: JOYCE UTTERBACK BUEHLER, SAN CLEMENTE, CA (US)

(21) Appl. No.: 14/293,080

(22) Filed: Jun. 2, 2014

Related U.S. Application Data
(60) Provisional application No. 61/838,616, filed on Jun. 24, 2013.

(51) Int. Cl. G09F 23/00

(52) U.S. Cl. CPC G09F 23/00
USPC 40/618

(57) ABSTRACT

Hook material cut into shapes, symbols, letters or words that are attached to loop pile-type commercial grade carpeting to convey spatial and directional non-verbal messages are disclosed. The hook material adheres to the loop pile-type commercial carpet and has the ability to be changed at any time without the use of adhesives or chemicals. The hook material may further possess a desired color and/or texture as may be desired for a particular application, including areas having heavy pedestrian traffic and/or to enhance child education.

### CROSS-REFERENCE TO RELATED APPLICATIONS

The present invention claims priority to U.S. Provisional Patent Application Ser. No. 61/838,616, filed Jun. 24, 2013, entitled HOOKED MATERIAL CUT INTO SHAPES, SYMBOLS, LETTERS OR WORDS THAT WILL BE USED FOR ATTACHMENT TO COMMERCIAL GRADE CARPETING FOR THE PURPOSE OF CONVEYING NON-VERBAL SPATIAL AND DIRECTIONAL MESSAGES, the teachings of which are expressly incorporated herein by reference in their entirety.

### STATEMENT RE: FEDERALLY SPONSORED RESEARCH/DEVELOPMENT

Not Applicable

### BACKGROUND

The present invention is directed to hook material cut or formed into shapes, symbols, letters or words for imparting spatial and/or directional messages and information. As is well-known, children frequently have difficulties with spatial proximity while inside a structured setting, such as a classroom, and do not understand how close to sit or stand next to each other while in a line, seated on the floor, or making a circle, etc. Moreover, existing area rugs for the spatial organization of children are expensive and limited to a predetermined shape and size, for example a 9′×12′ rectangular shape. Such rugs do not allow the users to adjust the size or shape of the carpet area to fit their needs, and much less offer any systematic way of indicating specific positions thereon. As a consequence, considerable time is consumed by teachers and/or other supervising adults with having to explain and position children to sit or place themselves in a given position as is frequently employed to do group activities and the like. The inability to provide a very simple visual cue as to placement or position requires considerable time and effort to instruct or place children in the ideal positions.

Deficiencies in providing simple visual cues regarding spatial proximity are likewise prevalent in basic foot traffic routes in public places and private businesses where it is highly desired to move people along a desired pathway and in a specific direction. Along these lines, many adults and children miss important non-verbal directives that are usually displayed in places that go unnoticed, thus, impeding the flow and productivity of the business. While businesses use non-verbal directives to help with traffic flow of patrons that are usually displayed on walls or messages or symbols taped to the floor, such wall postings often go unnoticed by the patrons and the directives on the floors are often a trip hazard. The vast majority of time, individuals walking in a particular direction are by nature inclined to look down in the forward direction in which they are heading, which thus affords the greatest opportunity of providing the information necessary to convey to such individuals the appropriate information to reach their destination yet is seldom taken into consideration.

Unfortunately, there is lacking in the art any type of mechanism, and much less a very simplistic and easily deployed mechanism, through which spatial information and directional signs, symbols and the like can be readily and easily deployed as necessary. The present invention is specifically designed to overcome such deficiencies in the art and provide a solution for customizing spatial organization and directional flow for children and adults.

### BRIEF SUMMARY

The present invention is directed to conventional hook-type material that is cut or formed into any of a variety of shapes, symbols, letters, words, numbers and the like that are operative to be attached to a loop pile-type material, and in particular rugs, carpeting or other type of fabric-based flooring to thus enable the hook material to remain securely in position and impart desired information, such as spatial and directional messages, to individuals walking thereacross. Such hook material may take any of a variety of conventional hook-type materials known in the art, the most well-known being the VELCRO® brand of such materials. The fabrication of such materials into various shapes, symbols, letters, words and the like may be performed by any of a variety of conventional manufacturing methods known in the art.

In use, the user need only attach the hook material upon the loop pile-type flooring material according to a desired orientation and direction whereby the hook material will remain firmly in position until such time as it is desired to remove the hook material, which is accomplished by simply pulling the hook material away from the loop pile-type flooring material. The hook material may thus be repeatedly used and repositioned as necessary or desired.

To enhance the visual attractiveness of the hook material, it is understood that the hook material may be made from a variety of colorful materials and may further be configured to have fanciful artwork, logos (such as sports teams and the like), educational information or other desirable signage properties well-understood to those skilled in the art to thus enhance the visual effectiveness of the hook material and further its purpose in particular applications, such as child education and the like.

To that end, it is contemplated that the pieces of hook-material may be packaged to include a multiplicity of matching or complementary pieces that may be desired for a particular educational application or the like. For example, it is contemplated that such pre-packaged kits may include a plurality of holiday-themed pieces, a variety of geometric shapes, a collection of directional pieces (e.g., arrows and pedestrian-oriented information), the letters of the alphabet or any of a variety of number sequences. In this regard, it is contemplated that the hook-type materials of the present invention can be readily commercialized in a variety of formats that will be readily understood by those skilled in the art.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an elevational perspective view of a classroom-type setting having a rectangular rug or carpet-type material on the floor thereof, the rug/carpet material having a plurality of hook material members fashioned as various geographic shapes affixed to specific positions thereon;

FIG. 2 is a frontal perspective view of a hook material fashioned into a specific oval shape having information imprinted thereon operative to engage and interconnect with a loop pile-type material;

FIG. 3 is the classroom-type setting of FIG. 1 having an instructor making a presentation to a plurality of children wherein each respective one of said children are assuming a position corresponding with respective ones of the hook material depicted in FIG. 1.

FIG. 4 is a front view of a plurality of shapes and symbols that the hook material of the present invention may assume as may be desired for a particular application or purpose.

### DETAILED DESCRIPTION

The above description is given by way of example, and not limitation. Given the above disclosure, one skilled in the art could devise variations that are within the scope and spirit of the invention disclosed herein, including various ways of fashioning or configuring a hook material into a desired shape, symbol and the like and attaching such hook material onto position upon a loop pile-material, and in particular a loop pile-type flooring such as commercial grade carpeting, for use in displaying spatial or directional information. Further, the various features of the embodiments disclosed herein can be used alone, or in varying combinations with each other and are not intended to be limited to the specific combination described herein. Thus, the scope of the claims is not to be limited by the illustrated embodiments.

In this regard, the present invention is directed to a hook material having a desired shape that attaches to a loop pile-type material, such as industrial/commercial grade carpeting, and conveys a directional message of where to sit, stand, or a path to follow. As stated above, children have difficulties with spatial proximity while inside a structured setting (such as a classroom), and often do not understand how close to sit or stand next to each other while in a line, seated on the floor, or making a circle, etc Likewise, many adults and children miss important non-verbal directives that are usually displayed in places that go unnoticed, thus, impeding the “traffic” flow and productivity of the business. The invention claimed here solves this problem, and will also assist the general public by providing non-verbal directions or pathways to follow that are placed on the loop pile-type carpeting where people have a tendency to look while they are walking and to convey a direction or a pathway to follow.

According to a preferred embodiment, the hook material may be any of a variety of conventional hook-type materials well-known and extensively utilized in the art. One such well-known brand is VELCRO® produced by Velcro Industries B.V. of the Netherlands. Such material is then formed, typically by cutting into the desired shape, symbol or the like, which may take any of the exemplary forms 60 set forth in FIG. 4, although it will be readily understood by those skilled in the art that a substantial number of other designs, shapes, symbols, letters, numbers and the like are expressly contemplated. Moreover, the shapes by which the hook material may be fashioned may take the form of and/or incorporate any type of fanciful artwork, and may also include product logos, sports teams, comic book characters and the like. Such hook material may also be designed to have a desired color and/or texture as may be desired for any of a variety of application, such as to increase durability and visibility or so as to enhance any of a variety of teaching or instructional applications.

An exemplary piece of hook material as contemplated herein is depicted in FIG. 2, whereby a piece of the hook material 50 is cut to have a generally oval shape and define an upper surface 52 having indicia thereon for conveying information. As will be understood by those skilled in the art, such indicia as shown on upper surface 52 is optional and the hook material 50 may only comprise a simple geometric shape. On the underside of hook material 50 is the hooking fabric 54, which as will be readily understood by those skilled in the art provides the attachment means to the loop pile material upon which the hook material 50 is placed. As is known, the simple ability of the hooking fabric 54 to engage with the loop pile material provides an attachment mechanism that enables the hook material 50 to remain in a desired location.

It is also expressly contemplated that the hook material may be specifically engineered to have a desired degree of fastening ability to the loop pile material to which the same is interconnected, such that the hook material binds more tightly to the loop pile material, as may be desired for heavy traffic-type applications, or may adhere to a lesser degree so as to facilitate easy removal and replacement of the hook material upon the loop pile flooring. As will further be appreciated, the sizing of the hook material may be variable and further, the color of the hook material may be changed as desired for the purpose of conveying various spatial and/or directional messages.

To use the invention, the hook material is placed hook side down, onto the loop pile industrial/commercial grade carpet in the desired location(s) and pressed down firmly on the loop pile carpet to adhere. Once placed on the loop pile carpet, the product will immediately convey non-verbal direction(s) as to where persons are to stand, sit or the pathway to be followed. To remove this product from the loop pile carpet, the user lifts a corner or edge of the product and pulls gently to disengage the entire product from the loop pile carpet, thus eliminating the non-verbal directional message or pathway to follow. Advantageously, the product uses the hook side 54 of the material to attach itself to loop pile industrial/commercial grade carpeting without using chemicals or adhesives. Its placement and shape allows spatial instruction and/or directional messages to be conveyed to the public by the user. Once placed on the loop pile carpet this product will not shift, lift, nor peel and is completely removable and reusable without the use of adhesives or chemicals.

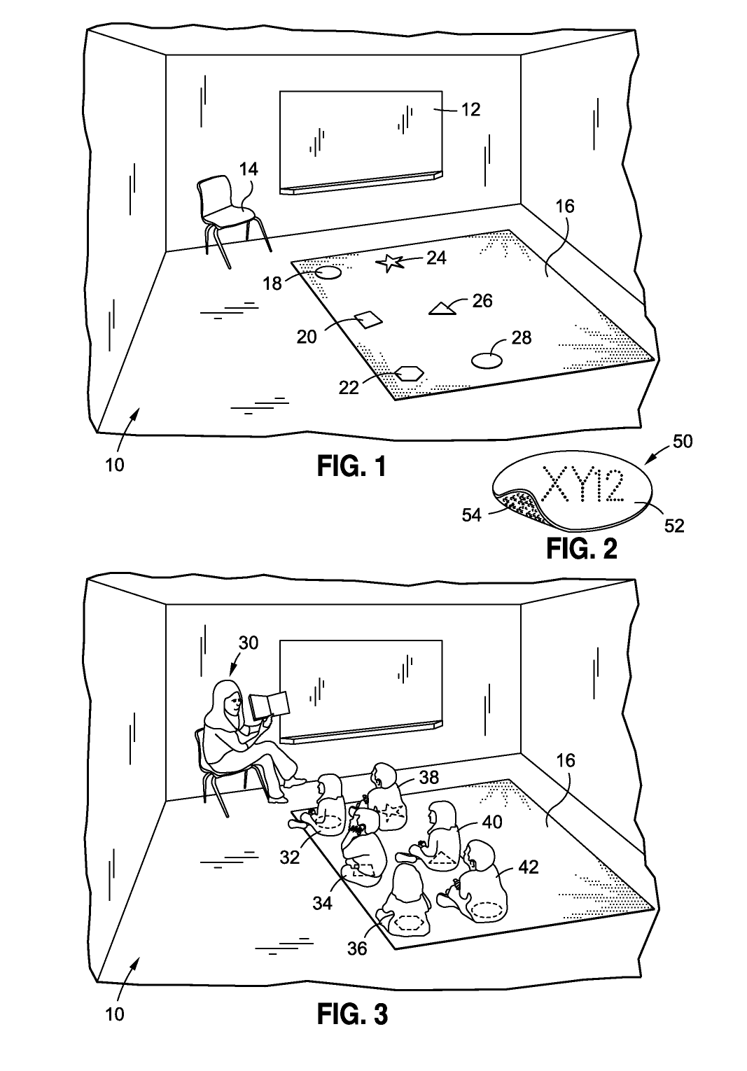

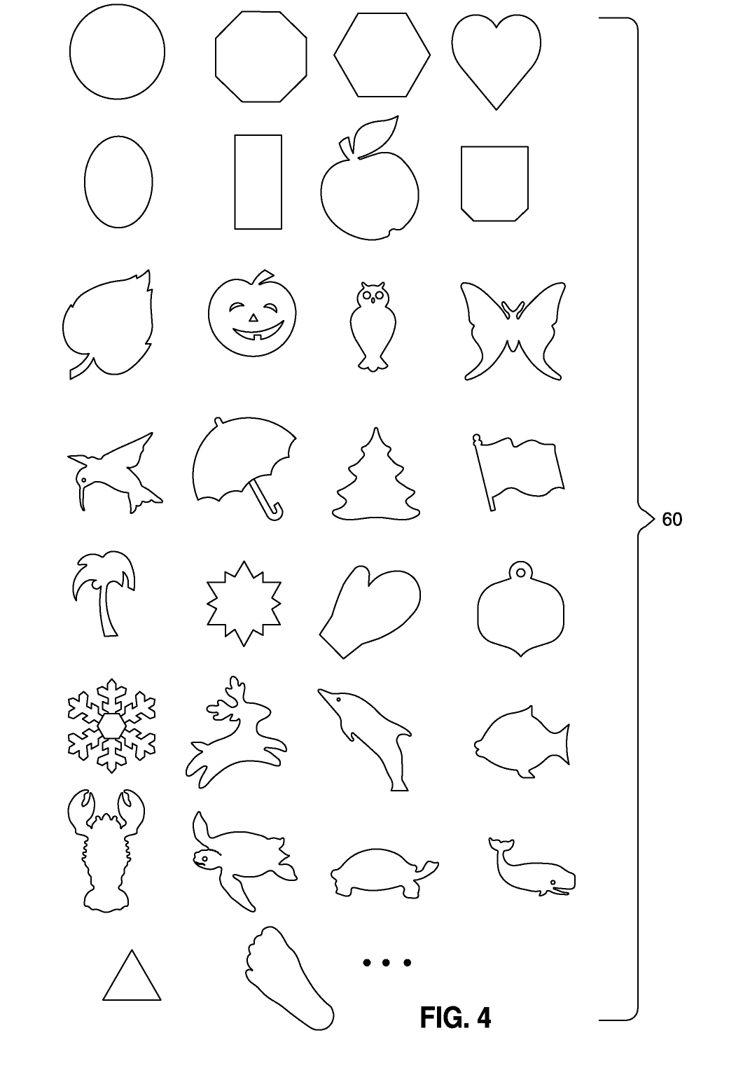

To illustrate the utility of the present invention, and referring now to FIGS. 1 and 3, there is shown a classroom-type setting 10 having a forward presentation area for providing instruction, which as depicted includes a chalk board or dry-erase type board 12 and front chair 14. Positioned on the floor of the classroom setting 10 is a rectangular shaped rug or carpet member formed from a loop pile-type material and having an upper surface. Upon the upper surface is a plurality of the hook-type members 18-28 of the present invention as constructed in accordance with a preferred embodiment. As shown, each respective hook-material member, 18-28, is shown to have a particular geographic configuration, with hook piece 18 and 28 having a generally circular configuration, hook-piece 20 having a generally square configuration, hook-piece 22 having a generally hexagonal configuration, and hook-pieces 24 and 26 having a star and triangular shaped configuration respectively. Such pieces 18-28 are thus maintained in a selective spatial relation to one another that may be chosen such that each particular hook-material member is an equidistant position relative another hook-material member.

Advantageously, such spatial relationship of the hook-members 18-28 will thus serve as a visual indicator to enable children, namely 32-36, depicted in FIG. 3, to sit in a particular location to thus enable an instructor 30 to provide instruction amongst a collection of children that are equally spaced apart from one another. Advantageously, due to the unique geographic shapes of each respective hook-member 18-28, each respective ones of the students 32-42 will know a seated position on the rug/carpet 16 without placement by the instructor 30, which in turn will not detract from the learning process as frequently occurs given the youthful and typically immature nature of children in a school-type setting. Along those lines, the hook-material pieces 18-28 may be selectively arranged in a number of patterns that can serve as an immediate visual cue for respective students to assume a certain position, which has been well-known to be an extremely time consuming task for educators and the like.

This invention is an improvement on what currently exists. Currently, the existing product for the management of spatial proximity for children is an area rug, which incorporates symbols, shapes or grids. The present invention provides the user with an inexpensive way to organize student spatial proximity while in a structured setting that can be configured in a customized shape and size to fit the needs of the user. Existing area rugs manufactured for this use do not provide the ability for changes and they do not help children with spatial proximity while standing in a line, making a circle, etc. Since these carpets are so expensive to purchase, they are also impractical for short term use. While businesses provide “traffic flow” directives that are often posted on the walls, the tendency of the public is to look down while they are walking and these wall directives often go unnoticed. The business directives that are placed on the carpeted flooring are often not securely adhered to the carpet and often create a trip hazard for patrons, or can ruin the carpeting leaving an adhesive residue when removed. The present invention thus provides a solution for customizing spatial organization, pathways, and directional messages for children and adults. This product adheres to loop pile-type commercial grade carpet and has the ability to be changed at any time without the use of adhesives or chemicals.

To enhance the use and commercialization of the hook-type pieces envisioned by the present invention, it is contemplated that multiple hook material pieces may be pre-packaged and sold as a kit, as may be desired for a particular application. For example, it is contemplated that such pre-packaged hook-type pieces may have a holiday or birthday-type theme whereby the various pieces of hook material are cut into fanciful configurations corresponding with the particular theme. It is likewise contemplated that such pre-packaged hook pieces may comprise a collection of directional or spatial-orientation pieces, such as arrows and pedestrian-type signals, may comprise alphabetical letters or number sequences, or may simply comprise a collection of geometric shapes or other types of fanciful type designs, such as those examples 60 shown in FIG. 4, which thus may be well-suited for a particular occasion or application. As discussed above, it is particularly envisioned that such pre-packaged material pieces will be well-suited for educational applications, including the education of small children in a classroom setting that must necessarily adhere to boundaries, respect for personal space and the like.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A hook material fashioned to assume a particular shape or symbol, said hook material being operative to be detachably fastened to a loop pile-type flooring selected from the group consisting of rugs and carpeting.

2. The hook material of claim 1 wherein said hook material assumes a geometric shape.

3. The hook material of claim 1 wherein the hook material is fashioned as a number.

4. The hook material of claim 1 wherein the hook material is fashioned as a letter.

5. The hook material of claim 1 wherein said hook material includes a fanciful design formed thereon.

6. The hook material of claim 5 wherein said fanciful design is selected from the group consisting of a logo for a branded product.

7. The hook material of claim 1 wherein said hook material is selected to have a desired color.

8. A kit for providing spatial and directional information upon an area of loop pile-type flooring comprising a plurality of hook members fashioned to assume a particular shape or symbol, said hook material of each hook member being operative to be detachably fastened to a loop pile-type flooring selected from the group consisting of rugs and carpeting.

9. The kit of claim 8 wherein said hook members are formed as sequential letters of the alphabet.

10. The kit of claim 8 wherein said hook members are formed as a sequence of numbers.

11. The kit of claim 8 wherein said hook members comprise a collection of directional information consisting of arrows and pedestrian-based traffic instructions.
